(19) United States
(12) Patent Application Publication
(10) Pub. No.: US 2015/0320033 A1
(43) Pub. Date: Nov. 12, 2015

(54) Pre-Emergent Seed Coatings and Growth Stimulator Compositions

(71) Applicants: Thomas Michael Schultz, Millsboro, DE (US); Arthur H. Finnel, Phila, PA (US); Wallace Pill, Lewes, DE (US)

(72) Inventors: Thomas Michael Schultz, Millsboro, DE (US); Arthur H. Finnel, Phila, PA (US); Wallace Pill, Lewes, DE (US)

(21) Appl. No.: 14/516,165

(22) Filed: Oct. 16, 2014

Related U.S. Application Data
(60) Provisional application No. 61/991,978, filed on May 12, 2014.

(51) Int. Cl. A01N 25/04; A01C 1/06; C05G 3/00; C05B 17/00; C05C 5/04

(52) U.S. Cl. CPC A01N 25/04; C05B 17/00; C05C 5/04; C05G 3/0076; A01C 1/06

(57) ABSTRACT

A bio-degradable seed coating composition for enhanced seed protection and propagation consists of a gelatin-based hydrogel formulation consisting of a naturally derived, hydrophilic protein, a sulfated or non-sulfated polysaccharide, a divalent cationic salt, and an azeotropic drying agent. The coating is readily applied to the seed and has enhanced drying functionality. The composition adheres to the seed surface and protects the seed during storage for improved shelf life while still being readily hydrated and water absorbent once planted in the respective growing medium.

### CROSS-REFERENCE TO RELATED APPLICATIONS

The present application claims the benefit of priority of U.S. Provisional Appln. No. 61/991,978 filed on May 13, 2014.

### FIELD OF THE INVENTION

The present invention relates generally to agricultural and horticultural applications and improved methods for enhanced seed protection and propagation. More specifically, the present invention is focused on improved hydrogel compositions and methods for their use in enhanced seed germination, propagation, and plant growth for increased crop production and yields.

### BACKGROUND OF THE INVENTION

There have been numerous biotechnological and agricultural advances over the years utilizing seed and plant hybridization techniques yielding new species and greater crop yields. Methods for enhanced seed germination and embryonic plant development have also been explored but there is still much in the area for improvement. Vegetation has been utilized to provide aesthetic value and soil stabilization for many years. One particular problem with vegetation is the time that it takes for the vegetation to propagate and/or root into the soil. Seed germination suffers from the deficiencies of slow root growth and inadequate water retention. To facilitate vegetation growth, prefabricated seed carriers were developed, such as disclosed in for example, U.S. Pat. No. 2,648,165 to Nestor; U.S. Pat. No. 2,826,865 to Chohamin; U.S. Pat. No. 2,909,003 to Marshall; and U.S. Pat. No. 3,914,901 to Muldner.

Seed carriers are well known in the art and often suffer from problems in that they are difficult to handle, contain non-biodegradable components, contain non-homogenous mixtures, suffer poor water retention characteristics, and have a poor shelf life. Most of the seed carriers developed have utilized synthetic nettings, woven and other sheet materials as support media. Nettings often are too weak to provide sufficient soil stabilization, have a tendency to tear during application, and are otherwise generally difficult to handle. The synthetic materials are expensive, and, being non-degradable, when the seeds germinate and the young seedlings/plants break through the soil and grow upwards, the non-degraded matting tends to suppress the vegetation growing beneath. The netting can also become dislodged by increased traffic and high winds. Eventually the netting must be removed by hand and since this often tears apart the soil erosion of the topsoil may result.

U.S. Pat. No. 6,557,298 to Obert et. al. discloses and claims a method for It teaches any hydrogel treating a seed, comprising forming on the seed a coating comprising a dry mixture of a hydrogel and an active ingredient so that the plant growth is stimulated. The hydrogel has a saturation water content and the dry mixture has a water content less than about 4% by weight of the saturation water content.

The active ingredient is selected from the group consisting of pesticides, selective herbicides, chemical hybridizing agents, auxins, antibiotics and other drugs, biological attractants, growth regulators, pheromones, dyes and combinations thereof. The hydrogel and the method for its' application resists loss of coating due to abrasion encountered during handling, storage, transportation, distribution and sowing, and also provides long lasting treatment of the seed with that effect and even, if so desired, provides such treatment to the plant that later emerges from the seed.

U.S. Pat. No. 4,779,376 to Redenbaugh discloses and claims of botanic seed encapsulated in a water saturated hydrogel capsule together with at least one adjuvant capable of affecting the botanic seed, the resulting plant body or the environment. The hydrogel capsule remains wet and is formed from a gel agent selected from the group consisting of alginate, carrageenan, locust bean gum and a number of other suitable gel agents known in the art. The adjuvant in the hydrogel capsule is selected from the group consisting of pesticides, herbicides, insecticides, fungicides, fumigants, repellants, rodenticides, fertilizers, nutrients, sugars, carbohydrates, adenosine triphosphate, microorganisms, growth regulating agents and the like.

U.S. Pat. No. 5,572,827 to Conrad et. al. discloses a method of applying a cross-linked hydrogel coating to embryonic plants to improve early plant growth by controlling the amount of cross-linking, comprising building up a dry coating consisting of a water-soluble hydrogel in powder form, said powder being capable of cross-linking reaction with polyvalent metal ions when hydrated to gel form. In this invention the hydrogel coating derives from an alginate powder. The individual powder-coated embryonic plants are then placed or immersed into a water bath free of polyvalent metal ions to partially hydrate the coatings. Before the coatings are fully hydrated, said bath is modified by dispersing cross-linking polyvalent metal ions therein. The polyvalent metal ions diffuse into the coatings and form an inwardly decreasing concentration gradient therein, the outer portions of the coatings being more highly cross-linked than the inner portions. The polyvalent metal ions in the coatings are in a uniformly partially cross-linked condition which allegedly promotes leaf emergence and plant vigor.

U.S. Pat. No. 5,771,632 to Liu et. al. discloses an artificial seed that has a hydrophobic powder padded layer or coating surrounding the seed that has a sealing material to prevent contamination thereof. This powder layer, 2-30 mm preferably 5-20 mm in thickness, consists of numerous fine sandy hydrophobic particles. The openings among the particles are small and block micro-organisms from penetrating this dry and nutrient-less layer into the seed, but not enough to block needed oxygen. The hydrophobic nature of the particles is also effective to block water permeation and microbes therein, but not effective to block the tissue to grow out of the seed. After sowing and watering the artificial seed in non-sterile soil, the water-soluble film is dissolved but the powder layer is still kept in position by the surrounding soil. The germination process is very much like that of a real botanical seed.

U.S. Pat. No. 7,921,598 to Nishiyama et. al. teaches a gel-coated seed comprising: a seed of a plant; and a coating layer disposed on the seed, said coating layer comprised of an alginic acid-based gel-forming solution containing grains of carboxymethylcellulose-based water-containing hydrophilic polymer dispersed therein. The alginic acid-based gel-forming solution is formulated in the presence of a gelling agent consisting of a multivalent ion such as calcium, sodium or potassium chloride and/or mixtures thereof. The carboxymethyl-cellulose-based, water-containing hydrophilic polymer is coated onto the seed at a concentration of between 0.2% by weight and 0.8% by weight. The resulting gel-coated seed has sufficient strength for handling and enhanced seedling survival both immediately after production thereof and after recovery following storage under drying. In an article by A. Rehman et al.; Plant Soil Environ., 57, 2011 (7): 321-325 it is asserted that that hydrogel addition to the soil was effective in improving soil moisture availability and thus increased plant establishment. It is also well documented that the addition of gel-polymers has the potential to improve plant vegetative growth by retaining a higher moisture content therein. Seed is coated when growers need a precision-sown crop and the non-coated (“raw”) seed is too small, light or variable in size or shape to be sown accurately with existing equipment. Precision sowing is desirable when growers need singulation, e.g., for cell-tray plant production in a greenhouse or strict control of spacing or depth of placement (e.g. onion spacing is critical to achieve desired bulb size at harvest) Singulation and controlled spacing are also vital for crops that are direct sown and then thinned back to the desired population. The field thinning operation is faster, cheaper and more accurate when coated seeds are used.

U.S. Pat. No. 6,458,386 to Schacht et. al. discloses and claims a composition comprising a biopolymer matrix comprising cross-linked vinyl-derivatives of gelatin, or co-polymerized methacrylamide modified gelatin with vinyl-modified polysaccharides, or cross-linked vinyl-substituted polysaccharide and gelatin being physically entrapped in a semi-interpenetrating network. Preferably, said polysaccharide comprises dextran or xanthan. The present invention also relates to a wound dressing or a controlled release device comprising said biopolymer matrix. The matrix may be in the form of a hydrated film, a hydrated or dry foam, dry fibers which may be fabricated into a woven or non-woven tissue, hydrated or dry microbeads, dry powder, or covered with a semi-permeable film so as to control the humidity of the wound covered with the dressing, with the permeability chosen so as to maintain this humidity within a therapeutically optimal window.

WO 1997036471 to Chown teaches a coating composition of the that comprises gelatin, water and a desiccant. The composition is preferably film forming and preferably it also includes one or more active ingredients, such as, nutrients, trace elements, pesticides, nematicides, fungicides, herbicides, nematicides and safeners. The composition is coated onto plant seeds or plant propagules using any suitable coating device such as a rotating auger steering system, a conveyor steeping system or an electrostatic system. The coating is dried and the coated seeds are planted or stored for future use.

U.S. Patent Publication 20120220454 A1 to Chen discloses seed coating compositions that promote seedling establishment through water retention or water absorption. One or more layers of the seed coating composition act as a wetting agent, which wets the adjacent/surrounding area of soil around the seed. It is asserted that the coating compositions also promote the ability to maintain or sustain active ingredients or agricultural compounds in the soil, such as pesticides, herbicides, and the like, and they are not lost with water runoff or drainage, and thus not available for grass and plants and the like. The seed coating compositions are comprised of one or more layers comprise guars or guar derivatives as improved film-formation agents that can likewise act as a binding agent. The binder is selected from the group consisting of molasses, granulated sugar, alginates, karaya gum, jaguar gum, tragacanth gum, polysaccharide gum, mucilage and any combination thereof. The coating may also include at least at least one agricultural active selected from the group consisting of herbicides, plant growth regulators, crop dessicants, fungicides, bacteriocides, insecticides, herbicides, fungicides, and mixtures thereof.

The present invention then, is hydrogel formulation useful as a seed coating that is superior to those described above and is focused on compositions and methods for improved seed germination, propagation, and plant growth for increased crop production and yields comprising hydrogel-coated seeds wherein the coating is comprised of a hydrogel composition consisting of a gelatin comprised of naturally derived proteins and one or more polysaccharides. The composition is therefore bio-degradable and stimulates plant growth and plant development without any chemical residuals left in the soil.

Hydrogels are comprised of networks polymer chains that are hydrophilic, in which water is the dispersion medium. They are highly absorbent and can contain over 99.9% water within natural or synthetic polymers. Hydrogel materials also possess a degree of flexibility very similar to natural tissue, due to their significant water content. Common uses known in the art include scaffolds in tissue engineering in which the hydrogels contain human cells to repair tissue or are used for cell culture. Environmentally sensitive hydrogels are also known as ‘Smart Gels’ or ‘Intelligent Gels’ and these have the ability to sense changes of pH, temperature, or the concentration of metabolite and release the active drug or other incorporated material as result of such a change. As such they are useful as sustained-release drug delivery systems and other uses where water absorption and retention is important.

### BRIEF DESCRIPTION OF THE DRAWINGS

FIG. 1 is a table showing the composition make-up of twenty two (22) seed coating compositions of the present invention for comparative purposes.

FIG. 2 is a table showing the seedling growth results of twenty two (22) seeds of corn that have been coated with different compositions of the present invention for comparative purposes.

### SUMMARY OF THE INVENTION

The present invention comprises improved hydrogel formulations and their use as seed coating materials in agricultural and horticultural applications, seed production and plant physiology/biochemistry. More specifically, the present invention is a protein derived, bio-degradable hydrogel composition comprising gelatin and either an un-sulfated or a sulfated polysaccharide with an azeotropic drying agent and a divalent cationic salt incorporated therein. The azeotropic drying agent enhances the properties of the hydrogel coat when dried which has superior osmotic and uniform integrity. The coating also has super-absorbent characteristics that make it a useful seed coating material which protects the embryonic seed tissue prior to planting during dry storage and later stimulates seed propagation, growth and development once moistened and watered after planting. The gelatin is preferably a denatured animal or vegetable protein such as from lupin, pea, or soy, and the polysaccharide is selected from the group consisting of glucosamine, chondroitin sulfate, carrageenan, sulfated starch and optionally may include the synthetic sulfated celluloses, dextran and similar polysaccharides.

Preferably, the biodegradable hydrogel composition also contains a rheological modifier such as a cationic metal ion, a clay and the azeotropic drying agent enhances the uniform integrity of the hydrogel coating which reduces the need for repeated watering to saturate the seed during early stages of germination initiation. The hydrogel water retention and slow release profiles provide a reservoir of water that the seed can draw upon on demand.

### DETAILED DESCRIPTION OF THE INVENTION

The present invention comprises formulations consisting of gelatin and sulfated polysaccharides that are combined into gel blends capable of forming a coating on seeds to stimulate for superior germination. These hydrogels are biodegradable and capable of absorbing large amounts of water which ultimately reduces the amount of water needed for germination to begin. The hard, semi-porous coating protects seeds during storage and transport. After seeding, the coating attracts and absorbs soil water and releases it on demand during germination. Added nutrients, plant protectants and bio-actives may also be added to promote seed growth

Many hydrogels as discussed above have been used in a similar capacity in the past. However, these hydrogels are formed from alginates, carrageenan gums, and either a polyacrylamide or polyacrylic acid polymer backbone. The base technology is often used commercially in materials known as super absorbents and is comprised of synthetic polymers that have significant water retention capabilities but extremely poor biodegradability. Hence, while they serve to provide a water-on-demand resource for new seeds in the planting processes utilized in agriculture, forestry and land conservation, their continued residence in the soil is a problem that results in soil contamination and water run-off pollution.

The hydrogel compositions of the present invention comprise a protein-derived gelatin formulated with a sulfated polysaccharide and further includes an azeotropic drying agent comprised of a low molecular weight alcohol or ketone. The protein-derived gelatin forms a hydrated gel and the polysaccharide interspersed within the polymeric chains, all of which are inter-connected and complexed with water through hydrogen bonding.

The alcohol or ketone significantly enhances the coating characteristics of the hydrogel/polysaccharide blend onto the embryonic seed coating as well as its' ability to dry thereon and coat the seed faster. The seed is first coated using a simple spray-on or fluid bed immersion and followed with a moderately hot forced air drying method. Suitable means to achieve this include fluid bed spray dryers, chamber dryers, rotary coaters, etc.

The azeotropic drying agent comprised of a low molecular weight alcohol or ketone, preferably ethanol or isopropanol. The use of alcohols to precipitate gelatin proteins from solution and then bind them to a surface is well known and the chemical physiology regarding gelation deposition is well documented. For specific methods and procedures, see for example, Gelatin Deposition by Ethanol, W. G. Crewther, Nature; 165, 680 (1951) which is hereby incorporated by reference. The coating delivers the seed in a form that is a hard non-deliquescent surface and the seed is larger, rounder, smoother, heavier and more uniform than the original seed. The coated seed can then be sown and planted with a belt, plate, cup, vacuum or other type of seed planter. The coated seed or “pills” can be placed individually within the tilled row in the ground with improved spacing and depth control. The pills also flow better through the seeding mechanism, because their surface is smoother and less tacky than that of non-coated seed and other hydrogel coated materials known in the art.

Preferably, a carrageenan (kappa or iota) gum or glucosamine is employed as the polysaccharide within the gelation/sulfated polysaccharide blend. It has also been surprisingly discovered that if a mono-valent or divalent metal salt such as calcium (Ca++) is added to the hydrogel composition, the gelatin component within the hydrogel is less likely to be liquefied by the alcohol/azeotropic agent when they are mixed together. The seed coating process is also improved if the azeotropic agent or alcohol is sprayed or misted onto seeds that have already been coated with the hydrogel/polysaccharide solution. When the agent/alcohol is sprayed or “misted” onto the formulation, the agent then seems to force a precipitation of the composition onto the seed quickly. When the agent/alcohol is mixed into the hydrogel/polysaccharide solution, the drying time for the hydrogel to harden onto the seed coat is approximately from about twenty (20) to about thirty-five (35) minutes. When the azeotropic alcohol is subsequently sprayed onto the seed after it is coated with the hydrogel, the seed coat surprisingly dries much faster in from about five (5) to about ten (10) minutes.

The monovalent or divalent cation salt is incorporated into the hydrogel composition as one of a number of suitable compounds selected from the group consisting of sodium nitrate (NaNO₃), sodium phosphate (Na₃PO₄), sodium hydrogen phosphate (NaH₂PO₄), calcium phosphate (CaPO₃), calcium nitrate (CaNO₃), calcium carbonate (CaCO₃), calcium chloride (CaCl₂), cupric sulfate (CuSO₄), cupric nitrate ((Cu(NO₃)₂), boron oxide (B₂O₃), magnesium sulfate (MgSO₃,) and magnesium nitrate (MgNO₃).

The seed coatings can also serve as a carrier composition and incorporate an additional agricultural active compound. Herbicides, fungicides insecticides and beneficial microbials that protect the seed and emerging seedling can be incorporated into the coating. For example, alfalfa seeds can be coated a hydrogel that also has rhizobacteria incorporated therein which can then be used to inoculate the field with beneficial microbials. The seeds are coated by putting the seed in a rotating pan and the seeds are then sprayed with a fine mist of water or other solvent as an adherent. A fine inert powder such as a clay or diatomaceous earth is then added to the coating pan. Each misted seed becomes the center of an agglomeration of powder that gradually increases in size. The pills are rounded and smoothed by the tumbling action in the pan, similar to pebbles on the beach. The coating powder is compacted compression from the weight of material in the pan.

A binding material is incorporated near the end of the coating process to harden the outer layer of the pill. Binders can also reduce the amount of dust produced by the finished product in handling, shipping and sowing. Care must be taken with binders to avoid delaying or reducing the germination percentage. The coated seeds of the present invention provide superior germination capabilities over un-coated seeds. As the data that is we found a 25% reduced amount of irrigation needed to initiate germination. The hydrogel apparently pulls water from the soil towards itself, stores that water, and then has it available for the seed on a continuous basis during germination.

An additional benefit in light of the new push towards “green” technologies is that the present invention utilizes environmentally friendly materials and manufacturing process based on bio-renewable starting materials, a water-based formulation and room temperature process parameters. Moreover, the coated seeds produced thereby require 25% less irrigation during germination. The hard, semi-porous coating protects seeds during storage and transport. After seeding, the coating attracts soil water and releases it on demand during germination. Added nutrients, protectants and bio-actives may be added to promote seed growth.

The seed coating hydrogel compositions also contain an azeotropic drying agent comprising a low molecular weight alcohol or ketone. The alcohols and ketones included in the composition provide both an azeotropic function and consequently a concomitant dried seed coating with a degree of porosity needed for seedling respiration. The drying agent enhances the integrity and osmotic gradient of the dried hydrogel coat which results in superior seedling emergent physiology and growth characteristics. As a result of the uniform application and adherence qualities, the resulting coatings are substantially uniform in diameter such that flow of the seeds during application (e.g., spraying, rotary dispersal scattering) is improved. Moreover the type of alcohol or ketone incorporated into the seed coating hydrogels of the present invention may be tailored to and determined by the type of seed (and consequently the type/species of plant derived therefrom) that is to be coated. In other words, the type of alcohol or ketone incorporated into the hydrogel will be determined by the plant and seed variety that exhibits the best results.

Preferably, the alcohol useful in the practice of the present invention is an ethanol, propanol, isopropanol, butanol, isobutanol, 1,2-diydroxypropanol, 1,3-dihydroxypropanol, 1,2-dihydroxybutanol, 1,3-dihydroxybutanol, 1,4-dihdroxybutanol, polyols of pentane, hexane and higher carbon lengths and any combination thereof. In place of the alcohol in some formulations, a ketone may be used as it will provide better drying and coating results for a particular seed type. In these cases, the low molecular weight ketone useful in the practice of the present invention is acetone, butanone, pentanone, and the like.

The ability of the hydrogel formulations of the present invention to promote seedling establishment via non-deliquescent hydrogel seed coatings will minimize the yield loss of crops, grasses, shrubs and the like and can maintain and improve the quality of the seeds and avoid the spread of harmful organisms. This present invention relates to compositions and methods related to seed coating that reduce the amount of water required during early germination and the subsequent seedling establishment, which has an impact on improving yield of crops, as well as agricultural and horticultural plants, shrubs, trees, grasses and the like. In one embodiment, the invention relates to compositions and methods related to inclusion in the seed coating of materials such as pesticides, fertilizers, herbicides, and the like, typically lost to water runoff or drainage when used as deposits or sprays in broad field applications (wherein when lost to runoff or drainage, such agricultural compounds are not available for grass and plants and the like). The hydrogel formulations of the present invention can increase the yield of crops or to secure the crop in very hostile areas (non irrigated zones, warm to hot climates, windy areas, scarce precipitation, or a combination of these). Some targeted markets include: agriculture for non-irrigated crops (including but not limited to wheat, cotton, etc); agriculture for irrigated crops (including but not limited to horticulture-based plants); arboriculture, forestry and gardening; golf courses; sport and park turf; seeding additive for plant nurseries; and fruits, among others.

The specific type of hydrogel used in each formulation may be specific tailored to each seed species for even more enhanced germination and growth. For example, tomato seeds require a lot of water and a great deal of wetting initially and then a lighter steady amount during the initial germination stages. One of the hydrogels reduced the water needs by 25%. Another hydrogel version did the same with fescue, and a third version with garden beans.

It was surprisingly and unexpectedly discovered that hydrogels, comprised of a protein derived gelatin and either a sulfated or non-sulfated (neutral) polysaccharide will provide an effective seed coat hydrogel that has the dual advantage of being both biodegradable and obtainable from renewable resources. The protein gelatin material is derived from a bovine, porcine, soy or other high protein source. The hydrogels of the present invention may optionally also include a clay (a bentonite or kaolin, for example) therein so as to provide the hydrogel the added benefit of durability and rigidity during dry storage for easier transport and better shelf life. Furthermore, the clays also provide an additional immediate hydration upon first wetting. The hydrogel formulation of the present invention is prepared as follows. One or more sulfated polysaccharides is mixed in an aqueous solution of the gelatin, the alcohol/ketone component and and then allowed to gel. In some embodiments of the invention, a cross-linking agent is added after the gelatin and polysaccharide are mixed together. The formed hydrogel is then used to coat the seeds of interest. Typically the seed mixture is slurried and then dried at a temperature that is not adverse to the particular seeds physiology until the hydrogel hardens, i.e., generally under 135° F. In another embodiment of the invention a desiccant may be added at room temperature or alternatively a combination of heat and vacuum may be used.

Furthermore, the coated seeds also have a non-deliquescent property, that is, unlike modified starches, derivatized, and similar grafted polymeric coatings, ambient water vapor absorption is not an issue, enabling better seed storage, plantability and controls for in-field applications.

The gelatin/polysaccharide formulations the present invention will be comprised of from about 20× to about 150× its weight with water when contacted upon wetting. The hydrogel formulations may also be prepared with a cross-linking agent selected from the group comprising epoxy forms of sugars, amido-sugars, amido-polyethylene glycols and like compounds capable of forming an aldol-, a Mannich-, or a Maillard-like reaction with the gelatin. Any source of gelatin and other proteinaceous materials able to form gels are contemplated within the present embodiment including but not limited to porcine, porcine skin type A, bone, bovine hide and skin types A or B, soy protein isolates and engineered polypeptides.

The coating compositions comprise at least one layer coating all or part of the seed, the layer selected from the group consisting of gelatin, a sulfated polysaccharide, and may include glucosamine, chondroitin, dextran, cellulose, and optionally one of guar, derivatized guar, hydroxypropyl guar, carboxymethyl guar, carboxymethyl hydroxypropyl guar, starch, derivatized starch, cationic starch, corn starch, wheat starch, rice starch, potato starch, tapioca, waxy maize, sorghum, waxy sarghum, sago, dextrin, chitin, chitosan, alginate compositions, xanthan gum, carageenan gum, gum karaya, gum arabic, pectin, cellulose, hydroxyl-cellulose, hydroxyl-alkyl cellulose, hydroxyl-ethyl cellulose, carboxy-methylhydroxyethyl cellulose, hydroxyl-propyl cellulose, a derivative of any of the foregoing and a combination of any of the foregoing. The polysaccharide may be partially or fully sulfated. It is understood, however, that various counter ions can be utilized, including but not limited to halides (e.g., chloride, fluoride, bromide, iodide), phosphate, sulfate, methylsulfate, and mixtures thereof. The most preferred polysaccharide useful in the practice of the present invention is a caragennan gum, and most preferred is the kappa or iota form thereof.

Whereas these polysaccharides are preferred, it is important to make a distinction between two classes of polysaccharides. Structural polysaccharides are those such as, but not limited to, cellulose and chitin. These are insoluble in water due in large part to β-linkages (1-4 β-linkages in the case of cellulose and chitin). These linkages cause the polysaccharides to be more difficult to hydrolyze and obtain glucose recovery. The effect of this β-linkage requires structural polysaccharides to be at least partially sulfated on order to be useful due to their lack of solubility otherwise.

Another embodiment of the present invention is the inclusion of clays in the hydrogel formulation which were found to modify the behavior of the hydrogels in an unanticipated and unexpected manner. The inclusion of clays in the formulation cause gelatin-based hydrogels to change their rheological characteristics, a performance effect due to a change in the compositions' overall ionic charge. Moreover, it was surprisingly found that this behavior is controllable by adjusting and balancing the clay type in a weight percent variation based on the total weight in order to either strengthen or reduce the rigidity of the hydrogel on demand without altering the water uptake characteristics. Suitable clays useful in the practice of the present invention include kaolin, bentonite, montmorillonite-smectite, illite, chlorite and mixtures thereof. In this manner, the clays not only modify the durability of the hydrogel composition, but also improve the hydration characteristics thereof and less water is needed from the surrounding environment to trigger seed germination. The hydrogel durability is enhanced during dry storage, and hydrogel rigidity is maintained in the same state for durability and rigidity during dry storage for easier transport and better shelf life. Furthermore, these clays provide additional and immediate hydration upon first wetting.

Preferably, polysaccharides based on dextran, cellulose, or other saturated cyclic organic hydrocarbon that has an oxygen content of at least n=1 relative to the hydrogen content is useful in preparing the hydrogel. The second part is the gelatin derived from a denatured protein chain of either animal or vegetable in origin. The hydrogel, once formed, may be coated onto a seed. The coating may be applied as a slurry or spray dried onto the seed. The hydrogel can also be slowly evaporated onto the seed coat but the preferred embodiment is by the application of low heat between 45° F. and 160° F., this being an effective means to form a dry shell about the seed in as little as 5 minutes. Preferably, the seeds are dried at a temperature range of from about 55° F. to about 170° F. Surprisingly this fast drying is unexpected as the excess water is removed more quickly than anticipated and in fact makes this discovery a benefit for not over-wetting the seeds. Alternatively flash drying can be used although care will be needed to protect the seeds from sudden heat over-exposure and desiccation.

Germination rates were shown to be accelerated in comparison tests in-vitro and in-vivo. In both environments seeds coated with the hydrogel germinated faster and resulted in seedlings that were more robust and became larger plants. The present invention also comprises a method to enhance seed protection and propagation, that consists of coating the seed with the hydrogel comprised of a gelatin/polysaccharide matrix/formulation which is then dried thereon. The seeds are first coated with the bio-degradable hydrogel that is then dried and hardened onto the seed coat by thermal exposure at a temperature of from about 20 to about 70 degrees centigrade. Optionally, the water content of the hydrogel formulation after preparation may be subsequently reduced by from about 1.0% to about 20.0% by the replacement of a portion of the water therein with an alcohol prior to coating the seeds in order to speed the drying process. In some situations, cellulose derivatives by themselves without gelatin may also beneficial.

The seed coating compositions of the present invention can also promote seedling establishment as one or more layers of the seed coating composition can be applied so as to act as a water reservoir agent which delivers water on demand to the seed. Additionally, the seed coating compositions promote seedling establishment by inclusion of active ingredients or agricultural compounds in the hydrogel composition. Further, described herein are coating compositions that promote the ability to maintain or sustain active ingredients or agricultural compounds in the son, such that the active ingredients are available or more readily available to plants, vegetation, grasses, trees, and the like. Seed germination requires ample watering, much of which is lost to runoff or drainage, and thus not available for the crops, grass and plants and the like. The seed composition may further comprise an additive to further promote growth and otherwise protect the embryonic seedling from invasive micro-organisms which feed on the proteins and polysaccharides of the coating and the young plant. These may comprise fertilizers, insecticides, fungicides and bacteriocides. Suitable fertilizers include mono- and dibasic ammonium phosphates and their calcium and magnesium salts, ammonium nitrates and mixtures thereof. Useful insecticides comprise azoxystrobin, cycloheximide, streptomycin, malaxyl, thiabendazole, copper sulfate, chlorothalonil, carbon disulfide, copper octanoate, mancozeb, tebuconazole, and mixtures thereof.

The following examples are provided to more specifically set forth and define the process of the present invention. It is recognized that changes may be made to the specific parameters and ranges disclosed herein and that there may be a number of different ways known in the art to change the disclosed variables. And whereas it is understood that only the preferred embodiments of these elements are disclosed herein as set forth in the specification and drawings, the invention should not be so limited and should be construed in terms of the spirit and scope of the claims that follow.

### Example 1

The glucosamine/isopropyl alcohol hydrogel and the glucosamine/dextran sulfate/isopropyl alcohol coating compositions were prepared by combining dextran sulfate with gelatin in a weight percent ratio range of from 30:70 to 70:30 wt/wt %, in the glucosamine/isopropyl alcohol solution with water at ambient temperature. The hydrogel was then dried for 12 hours at either a drying temperatures of from about 70° to 95° F. The hydrogel seed coating formulations of the present invention were prepared in four comparative blends and the following formulations when applied to seeds as coatings provided the following coating characteristics:

1. Gelatin/glucosamine sulfate—when dried using dry air heated to 130° F. for twelve (12) hours, the hydrogel produces a hard coating that is moderately osmotic when placed in water as it absorbs 100 times its' weight in water (H₂O).
2. Gelatin/glucosamine sulfate/dextran sulfate—when dried using dry air heated to 85° for F twelve (12) hours, the hydrogel produces a hard coating that is highly osmotic when placed in water as it absorbs 150 times it's weight in water (H₂O).
3. Gelatin/glucosamine sulfate/ethanol—when dried using dry air heated to 80° F. for three (3) hours, the hydrogel produces a hard coating that is moderately osmotic when placed in water as it absorbs 100 times it's weight in water (H₂O).

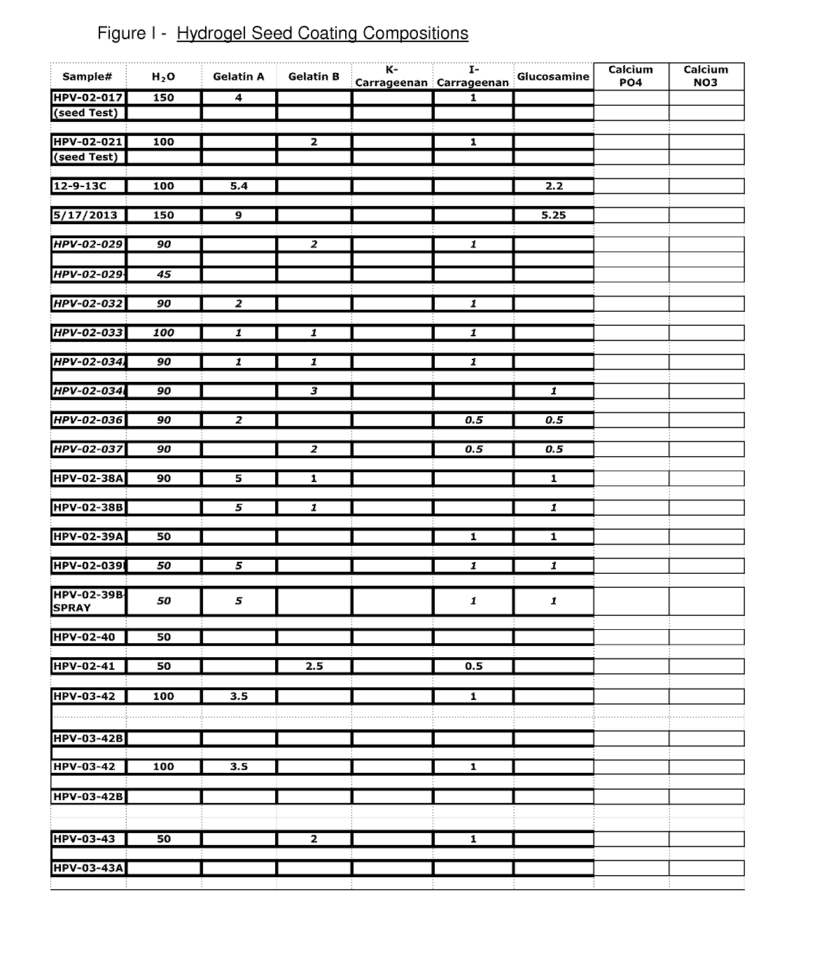

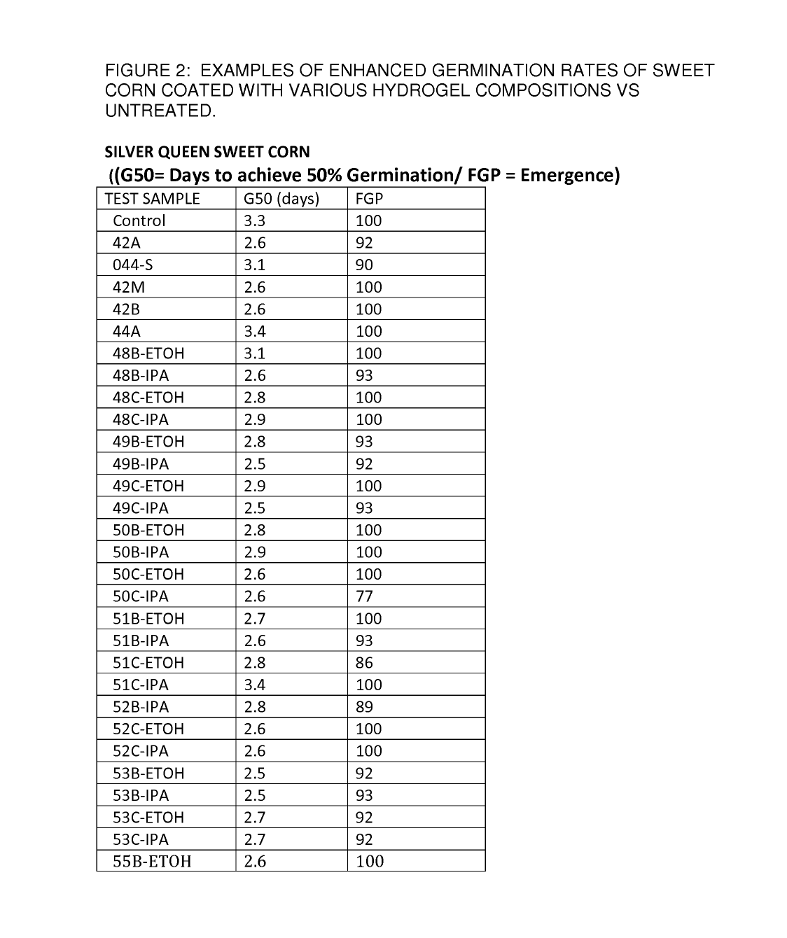

The hydrogel formulations set forth below were prepared by dissolving gelatin (either in an acidic solution A, or a basic solution B) in a weight percent ratio range of from 2:100 to 9:100 wt./wt. % in water at 75° C. The carrageenan, carrageenan/glucosamine, carrageenan/chondroitin, or carrageenan/glucosamine/chondroitin powder mixtures were added portion-wise to the gelatin solution. The resulting compositions were allowed to cool and form a gel. Hydrogel seed coating compositions were then prepared for application to various crop seeds. In the tables below, the gelatin/saccharide compositions were formulated in numerous ratios with a gelatin maximum of 9%, as formulations comprising higher gelatin amounts exhibited very rigid gel forms. The hydrogel seed coating compositions were then prepared for application to various crop seeds. In FIGS. 1 and 2 shown in the respective tables, the gelatin/saccharide compositions were formulated in numerous compositions with a gelatin maximum of 9%, since formulations using higher gelatin amounts resulted in the formation of very rigid gel forms not suitable for the purposes of this invention. In this manner selective blends can be made that perform with different water retention and drying properties according to the particular soil environment.

This data shows the ability to modify the hydrogel compositions in order to achieve specific functional properties according to the soil properties where the coated seed(s) will be planted and how this will dictate the other compounds added to the formulation to obtain the desired end results such as the inclusion of salts and other additives. Of particular note is that both the acidic and basic formulated gelatin groups can be blended with both calcium, phosphate and nitrate salts to surprisingly provide a very stiff hydrogel that is unexpected. Normally, under these conditions, the gelatin based hydrogels would lose the gelation properties due to the salt effect of the presence of the salts. For example, see sample numbers 62, 62A, 62B, 63, 63A, 63B, 64, 64A and 64B in the tables below. More surprisingly, if additional sulfated polysaccharides are also incorporated in the formulations, the gelatins achieve even maintain enhanced and unique swelling or water retention properties especially when two or more are blended into a gelatin base. See for example, in the tables below HPV-02-33 and HPV-02034. The carrageenan formulations surprisingly exhibit the best gelation properties. Carageenan gums typically can only tolerate miniscule amounts of salt before reacting with them and thereby lose their gelation properties. However here, when mixed with the gelatin, the carageenans remained thick gels in the presence of salts and is an unexpected advantage to the entire composition. In the Table below, Gelatin A=Acidic Gelatin and Gelatin B=Basic Gelatin, and K-Carrageenan=kappa-carrageenan and I-Carrageenan=Iota-carrageenan.

What is claimed is:

1. A bio-degradable seed coating composition for enhanced seed protection and propagation comprising a gelatin-based hydrogel formulation consisting of:
i. a naturally derived, hydrophilic protein;
ii. a sulfated or non-sulfated polysaccharide;
iii. a mono- or polyvalent salt, and
iv. an azeotropic drying agent.

2. The bio-degradable seed coating composition of claim 1 wherein said polysaccharide is selected from the group consisting of carrageenan, sulfated chitosan, sulfated starch, glucosamine, chondroitin, dextran, cellulose, partially derivatized guar, sodium cellulose, sulfate, dextran sulfate, mixtures thereof

3. The bio-degradable seed coating composition of claim 2 wherein said salt is selected from the group consisting of a monovalent or divalent cation such as sodium nitrate (NaNO₃), sodium phosphate (Na₃PO₄), sodium hydrogen phosphate (NaH₂PO₄), calcium phosphate (CaPO₃), calcium nitrate (CaNO₃), calcium carbonate (CaCO₃), calcium chloride (CaCl₂), cupric sulfate (CuSO₄), cupric nitrate ((Cu(NO₃)₂), boron oxide (B₂O₃), magnesium sulfate (MgSO₃,) and magnesium nitrate (MgNO₃).

4. The bio-degradable seed coating composition of claim 3 wherein said azeotropic drying agent is a low molecular weight alcohol or ketone

5. The bio-degradable seed coating composition of claim 4 wherein said polysaccharide is selected from the group consisting of iota, kappa and gamma carrageenans, glucosamine, chondroitin, and fucoidin.

6. The bio-degradable seed coating composition of claim 5 wherein said protein is derived from a porcine, porcine skin type A, bone, bovine hide types A or B, soy heavy protein extract, lupin and pea and genetically-engineered cells.

7. The seed coating composition of claim 6 wherein said drying agent enhances the integrity and osmotic gradient of the dried hydrogel coat

8. The seed coating composition of claim 7 wherein said low molecular weight alcohol is selected from the group consisting of ethanol, propanol, isopropanol, butanol, isobutanol, 1,2-diydroxypropanol, 1,3-dihdroxypropanol, 1,2-dihroxybutanol, 1,3-didroxybutanol, 1,4-dihdroxybutanol, polyols of pentane, hexane and higher carbon lengths and any combination thereof.

9. The seed coating composition of claim 8 wherein said low molecular weight ketone is selected from the group consisting of acetone, butanone, pentanone, and mixtures thereof.

10. The seed coating composition of claim 8 further comprising a rheology modifier.

11. The seed coating composition of claim 10 wherein said rheology modifier is a clay, a dessicant or silica gel.

12. The seed coating composition of claim 11 wherein said the protein/sulfated polysaccharide weight ratios in the seed coating composition are from about 100-40 weight percent to about 0-60 wt./wt. %.

13. The seed coating composition of claim 12 wherein said the protein/sulfated polysaccharide weight percent ratios in the seed coating composition are from about 10:90 to about 90:10 wt./wt. %.

14. The seed coating composition of claim 13 wherein the water content of the hydrogel formulation is reduced by from by about 1.0% to about 20.0% by the replacement of a portion of the water therein with an azeotropic drying agent prior to seed coating.

15. The seed coating composition of claim 14 wherein said alcohol is selected from the group consisting of ethanol, isopropanol, propylene glycol and mixtures thereof.

16. The seed coating composition of claim 15 wherein said composition further comprises an active additive selected from the group consisting of fertilizers, insecticides, fungicides and bacteriocides.

17. The seed composition of claim 16 wherein the fertilizer is selected from the group consisting of mono- and dibasic ammonium phosphates and their calcium and magnesium salts, ammonium nitrates and mixtures thereof.

18. The seed composition of claim 17 wherein said insecticide is selected from the group consisting of azoxystrobin, cycloheximide, streptomycin, malaxyl, thiabendazole, copper sulfate, chlorothalonil, carbon disulfide, copper octanoate, mancozeb, tebuconazole, and mixtures thereof.

19. A method to enhance seed protection and propagation comprising coating said seed with a gelatin-based hydrogel consisting of a naturally derived, hydrophilic protein in combination with a sulfated or non-sulfated neutral polysaccharide, a divalent cationic salt and a suitable azeotropic drying agent which is then dried thereon.

20. The method of claim 21 wherein said method further comprises drying the hydrogel coating onto the seed through the application of heat at a temperature of from about 60° C. to about 100° C.

21. The method of claim 22 wherein said hydrophilic protein is derived from porcine, porcine skin type A, bone, bovine hide types A or B, bovine skin types A or B, soy heavy protein extract, lupin and pea, and genetically engineered cells.

22. The method claim 21 wherein said sulfated polysaccharide is selected from the group consisting of sodium cellulose sulfate, dextran sulfate, sulfated chitosan, sulfated starch and mixtures thereof.

23. The method claim 22 wherein said sulfated polysaccharide is selected from the group consisting of the kappa or iota form of carageenan gum.

24. The method of claim 23 further comprising a rheology modifier comprising clay, a dessicant or silica gel.

25. The method of claim 24 wherein said clay is selected from the group consisting of kaolin, bentonite, montmorillonite-smectite, illite, chlorite and mixtures thereof.

26. The method of claim 25 wherein said the protein/sulfated polysaccharide ratios in the seed coating composition are from about 20-100 wt./wt. % to about 60-0 wt./wt. %.

27. The method of claim 26 wherein said the protein/sulfated polysaccharide ratios in the seed coating composition are from about 10:90 to 90:10 wt./wt. %.

28. The method of claim 27 wherein the seed coating hydrogel composition is dried and hardened onto the seed coat by thermal exposure at a temperature of from about 30 to about 70 degrees centigrade.

29. The method of claim 25 wherein the seed coating hydrogel composition is dried and hardened onto the seed coat by dessication at room temperature.

30. The method of claim 29 wherein the azeotropic drying agent is sprayed onto the seed after the hydrogel composition has been applied thereto which is then dried and hardened onto the seed coat by dessication at room temperature.
